(19) United States
(12) Patent Application Publication
(10) Pub. No.: US 2010/0072068 A1
(43) Pub. Date: Mar. 25, 2010

(54) SYSTEM FOR ELECTROPHORETIC STRETCHING OF BIOMOLECULES USING MICRO SCALE T-JUNCTIONS

(75) Inventors: Patrick Doyle, Boston, MA (US); Jing Tang, Cambridge, MA (US)

Correspondence Address: Technology Licensing Office;Masachusetts Institute of Technology, Five Cambridge Center, Kendall Square, Cambridge, MA, 02142-1493, US

(73) Assignee: MASSACHUSETTS INSTITUTE OF TECHNOLOGY, Cambridge, MA (US)

(21) Appl. No.: 12/594,766

(22) PCT Filed: Apr. 2, 2008
(86) PCT No.: PCT/US08/59105

§ 371 Date: Dec. 2, 2009

Related U.S. Application Data
(60) Provisional application No. 60/910,335, filed on Apr. 5, 2007.

(51) Int. Cl. B03C 5/02

(52) U.S. Cl. 204/643

(57) ABSTRACT

System for trapping and stretching biomolecules. A microfluidic device includes a symmetric channel forming a T-shaped junction at a narrow center region and three wider portions outside the center region. At least one power supply is provided to generate an electric potential across the T-shaped junction to create a local planar extensional field having a stagnation point in the junction whereby a biomolecule introduced into the microfluidic device is trapped at the stagnation point and stretched by the extensional field.

This application claims priority to provisional application Ser. No. 60/910,335 filed Apr. 5, 2007, the contents of which are incorporated herein by reference.

This invention resulted from NIEHS contract number P30 ES002109. The Government has certain rights in the invention.

### BACKGROUND OF THE INVENTION

This invention relates to a system for stretching biomolecules and more particularly to a system for trapping and stretching DNA molecules.

The ability to trap and stretch biopolymers is important for a number of applications ranging from single molecule DNA mapping¹ to fundamental studies of polymer physics². (Superscript numbers refer to the references appended hereto, the contents of all of which are incorporated herein by reference.) Optical or magnetic tweezers can be used to trap and stretch single DNA molecules, but they rely on specific modification of the DNA ends³. Alternatively, one end of the DNA can be held fixed and the molecule stretched with an electric field or hydrodynamic flow⁵. Untethered free DNA can be driven into nanochannels to partially stretch molecules^{6,7}. Hydrodynamic planar elongational flow generated in a cross-slot geometry has been used to stretch free DNA⁸ but trapping a molecule for a long time at the stagnation point is not trivial⁹. Electric fields have been used to either confine molecules in a small region in a fluidic channel¹⁰ or to partially stretch molecules as they electrophorese past obstacles¹¹⁻¹³, into contractions¹⁴ or through cross-slot devices¹⁵. Partial stretching occurs in these aforementioned electrophoresis devices because the molecule has a finite residence time¹⁴. Currently, simple methods do not exist to trap and stretch DNA or other charged biomolecules.

DNA can be physically envisioned as a series of charges distributed along a semiflexible Brownian string. Molecules can be electrophoretically stretched due to field gradients that vary over the length scale of the DNA. Deformation of a DNA will depend upon the details of the kinematics of the electric field^{12,16}. Electric fields are quite unusual in that they are purely elongation^{12,15,16}.

It is therefore an object of the present invention to provide a microfluidic device that is able to trap and stretch biomolecules using electric field gradients.

### SUMMARY OF THE INVENTION

In one aspect, the invention is a system for trapping and stretching biomolecules including a microfluidic device having a symmetric channel forming a T-shaped junction and a narrow center region and three wider portions outside the center region. At least one power supply generates an electric potential across the T-shaped junction to create a local planar extensional field having a stagnation point in the junction. A biomolecule such as DNA introduced into the microfluidic device is trapped at the stagnation point and is stretched by the extensional field. In a preferred embodiment, the symmetric junction includes a vertical arm and two horizontal arms, the three arms having substantially identical lengths and the width of the vertical arm being approximately twice the width of the horizontal arms.

In a preferred embodiment, the system includes two separate DC power supplies to adjust the location of the stagnation point. It is also preferred that corners in the center region of the microfluidic device be rounded. The vertical arm and the two horizontal arms preferably contain a substantially uniform electric field. In another preferred embodiment, the extensional field is substantially homogeneous. In a preferred embodiment, the biomolecule is DNA such as T4 DNA. It is also preferred that the electric potential have a Deborah number exceeding 0.5.

### BRIEF DESCRIPTION OF THE DRAWING

FIG. 1a is a schematic diagram showing the channel geometry of an embodiment of the invention.

FIG. 1b is a schematic diagram of an embodiment of the invention showing the location of uniform/elongational fields and a stagnation point.

FIG. 1c is a schematic diagram showing an expanded view of a T-junction.

FIG. 1d is a circuit diagram serving as an analogy of the channel of an embodiment of the invention.

FIG. 2a is a graph showing dimensionless electric field strength in the T-junction region derived from a finite element calculation.

FIG. 2b is a graph showing dimensionless electric field strength and strain rate for a trajectory.

FIG. 3a is a photomicrograph showing stretching of a T4 DNA molecule trapped at a stagnation point.

FIG. 3b is a photomicrograph showing steady state behavior of a T4 DNA molecule.

FIG. 3c is a graph illustrating mean steady state fractional extension of T4 DNA versus Deborah number.

FIG. 4 is a photomicrograph showing stretching of a λ-DNA 10-MER in the T-channel.

FIG. 5a is a graph of trajectories of 34 λ-DNA electrophoresis for field characterization.

FIG. 5b is a graph showing semi-log \hat{x} (t) traces for 15 of the trajectories shown in FIG. 5a that have crossed the homogeneous extensional region.

FIG. 5c is a graph showing semi-log ŷ (t) traces for the same 15 trajectories.

FIG. 6 is a graph showing mean square fractional extension for T4 DNA in a 2 μm-high PDMS channel.

FIG. 7 is a schematic diagram showing channel geometry using a different corner-rounding method.

FIG. 8 is a schematic diagram of a full cross-slot channel according to another embodiment of the invention.

FIG. 9 is a schematic diagram of an embodiment of the invention including an extra side injection part.

FIG. 10 is a schematic diagram of another embodiment of the invention including an electrokinetic focusing part.

### DESCRIPTION OF THE PREFERRED EMBODIMENT

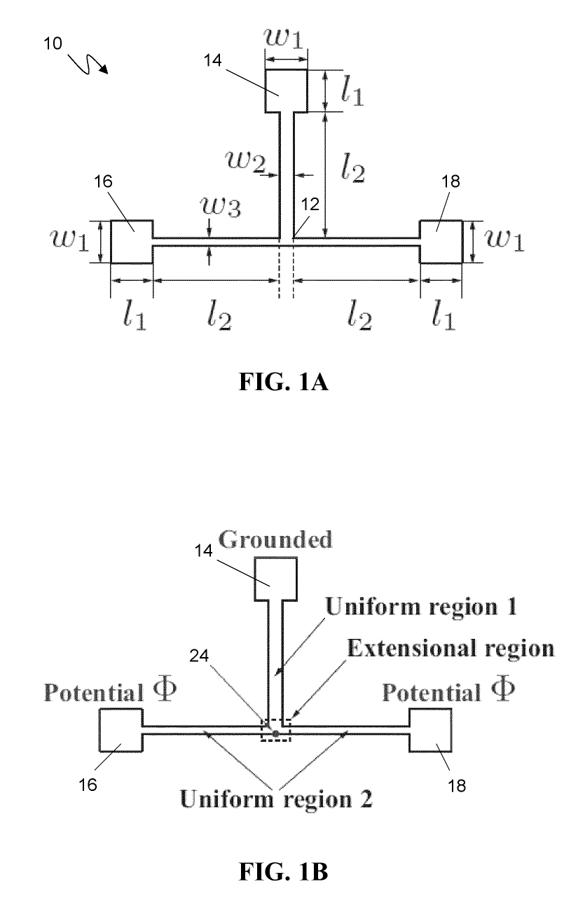

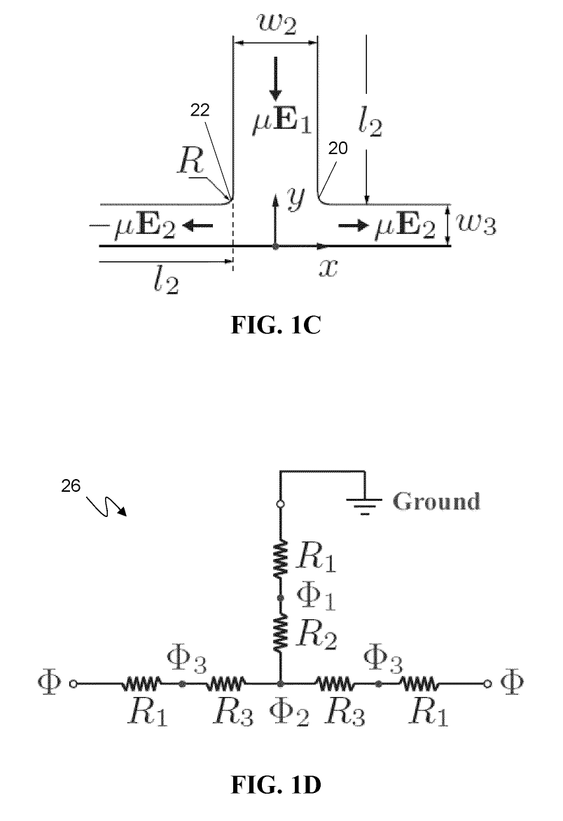

We have investigated the stretching of DNA molecules in a symmetric channel 10 comprising a narrow T-shaped part 12 in the center and the three identical wide parts 14, 16, and 18 outside as shown in FIG. 1(a). The vertical part and horizontal part of the T-junction have the same length l₂ while the width of the vertical part is twice the width of the horizontal part: w₂=2w₃. Hence the T-junction is equivalent to half of a cross-slot channel. The dimensions used in this investigation were: l₁=1 mm, l₂=3 mm, wᵢ=80 μm, w₂=40 μm, and w₃=20 μm. In order to suppress the local electric field strength maximum, the two corners 20 and 22 of the T-junction 12 were rounded using an arc with radius R=5 μm (FIG. 1(c)). When symmetric potentials are applied to the channel 10 in a manner as shown in FIG. 1(b), a local planar elongational electric field with a stagnation point 24 can be obtained within the T-junction 12 and uniform fields in the three straight arms. We use E₁ and E₂ to represent the uniform electric field obtained in uniform region 1 and uniform region 2, respectively.

Because l₁, l₂>>w₃, a simple circuit 26 as shown in FIG. 1(d) can be used to analogize this channel. The center T-junction region 12 is neglected and each straight part of the channel is represented with a resistor with resistance proportional to l/w. The potential at each point indicated in FIG. 1(d) can be solved analytically. The resulting field strengths in uniform region 1 and 2 are given by:

$$\vert {E}_{1} \vert = \vert {E}_{2} \vert = \frac{Φ}{3 {l}_{1} ( {w}_{3} / {w}_{1} ) + 2 {l}_{2}} \qquad ( 1 )$$

As a result, the resulting extensional field in the T-junction 12 is nearly homogeneous. The electrophoretic strain rate is approximately given by \dot{ε}≈μ|E₁|w₃ where μ is the electrophoretic mobility. For the remaining analysis, we non-dimensionalize the variables:

$$\hat{x} = \frac{x}{{w}_{3}} , \hat{y} = \frac{y}{{w}_{3}} , \hat{E} = \frac{E}{\vert {E}_{1} \vert} , {ɛ}^{\hat{.}} = \dot{ɛ} \frac{{w}_{3}}{μ \vert {E}_{1} \vert} \qquad ( 2 )$$

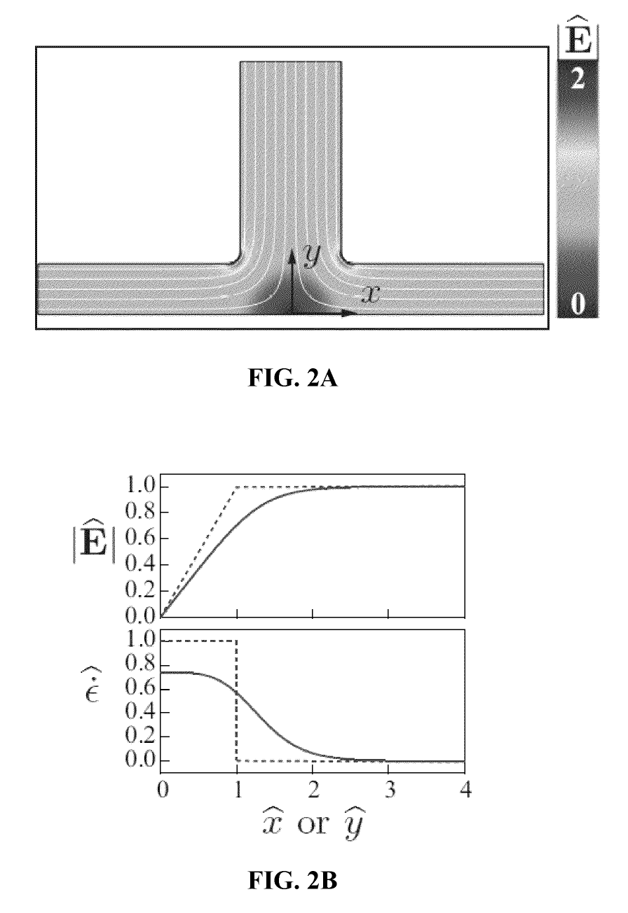

In FIG. 2(a), we show a finite element calculation of the dimensionless electric field strength |Ê| in the region around the T-junction 12. We assume insulating boundary conditions for the channel walls. The white lines are the electric field lines. Although the corners have been rounded, there is still a small local maximum in field strength at the corners. FIG. 2(b) shows the dimensionless electric field strength and strain rate in the junction 12. Due to symmetry, the data along ŷ=0 and \hat{x}=0 overlap. The electric field and strain rate for an idealized T channel without any end effects are indicated by the dotted lines. The entrance (or exit) region starts at about 30% of the length w₃ before the entrance (or exit) of the T-junction and extends a full length of w₃ into the uniform straight region. Within the T-junction 12, there is a homogeneous elongational field, but the strain rate is ≈0.74μ|E₁|/w₃ due to entrance/exit effects. The field kinematics was experimentally verified using particle tracking¹⁷.

We use soft lithography¹⁸ to construct 2 μm-high PDMS (polydimethylsiloxane) microchannels. T4 DNA (165.6 kilobasepairs, Nippon Gene) and λ-DNA concatomers (integer multiples of 48.5 kilobasepairs from end-to-end ligation, New England Biolabs) were used in this study. DNA were stained with YOYO-1 (Molecular Probes) at 4:1 bp:dye molecule and diluted in 5×TBE (0.45 M Tris-Borate, 10 mM EDTA) with 4 vol % β-mercaptoethanol. The stained contour lengths are 70 μm for T4 DNA and integer multiples of 21 μm for λ-DNA concatomers. The bottom two electrodes were connected to two separate DC power supplies and the top electrode was grounded. Molecules were observed using fluorescent video microscopy¹³.

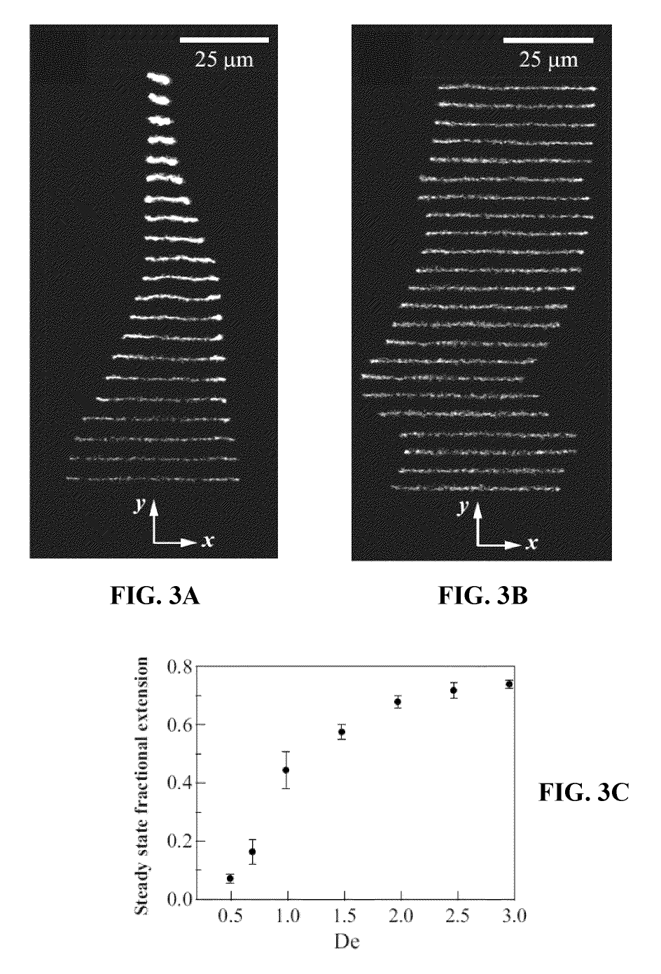

In a typical experiment, we first applied symmetric potentials to electrophoretically drive DNA molecules into the T-junction region and then trapped one molecule of interest at the stagnation point of the local extensional field (FIG. 3(a)). With the application of two power supplies we were able to adjust the two potentials individually and therefore freely move the position of the stagnation point. This capability of stagnation point control allowed us to trap any DNA molecules in the field of view even if it initially did not move toward the stagnation point. Furthermore, we could also overcome fluctuations of a trapped molecule. For example, if a trapped DNA begins to drift toward the right reservoir, the potential applied in the left reservoir can be increased so that the position of the stagnation point would reverse the direction of the drifting molecule (FIG. 3(b)).

The T4-DNA in FIG. 3 has a maximum stretch of ≈50 μm and extends just slightly beyond the region in the T-junction where homogenous electrophoretic elongation is generated. The dimensionless group which determines the extent of stretching in this region is the Deborah number De=τ\dot{ε} where τ is the longest relaxation time of the DNA (measured¹⁷ to be 1.3±0.2 s). In FIG. 3(c) we see that strong stretching occurs once De>0.5, similar to what is observed in hydrodynamic flows⁸. Each point in FIG. 3(c) represents the average of 15 to 30 molecules.

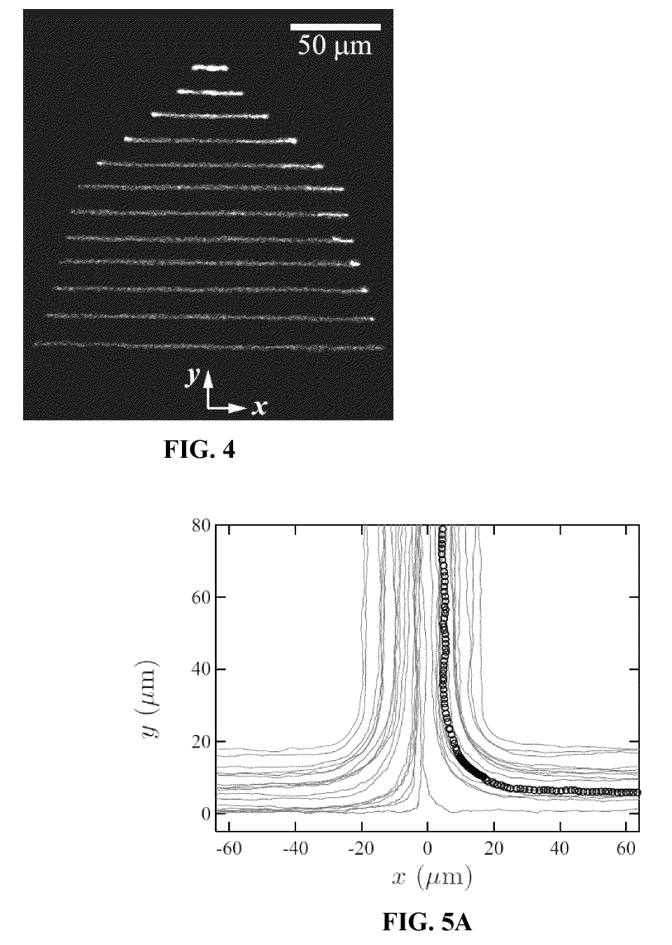

We next tried to stretch molecules which have contour lengths much larger than 2×w₃ (40 μm). In FIG. 4 we show the stretching of a concatomer of λ-DNA which has a contour length of 210 μm (10-mer, 485 kilobasepairs). As the molecule enters the T-junction it is in a coiled state with mean radius of gyration ≈2.7 μm¹⁹. Initially the stretching is governed by De due to the small coil size. However, as the arms of the DNA begin to extent into regions of constant electric field, stretching occurs due to a different mechanism. For stretched lengths>>2×w₃, the chain resembles a set of symmetrically tethered chains (with contour lengths one-half that of the original chain) in a homogeneous electric field. Stretching still occurs, but is now governed by the Pe=μElₚ/D_{1/2} where μ is the electrophoretic mobility (1.35±0.14×10⁻⁴ cm²/(sV)), lₚ is the persistence length (≈53 nm) and D_{1/2} is the diffusivity of a chain with a contour length half that of the original chain (≈0.062 μm²/s for this 10-mer¹⁹). The molecule in FIG. 4 reaches a final steady state extension which is 94% of the full contour length.

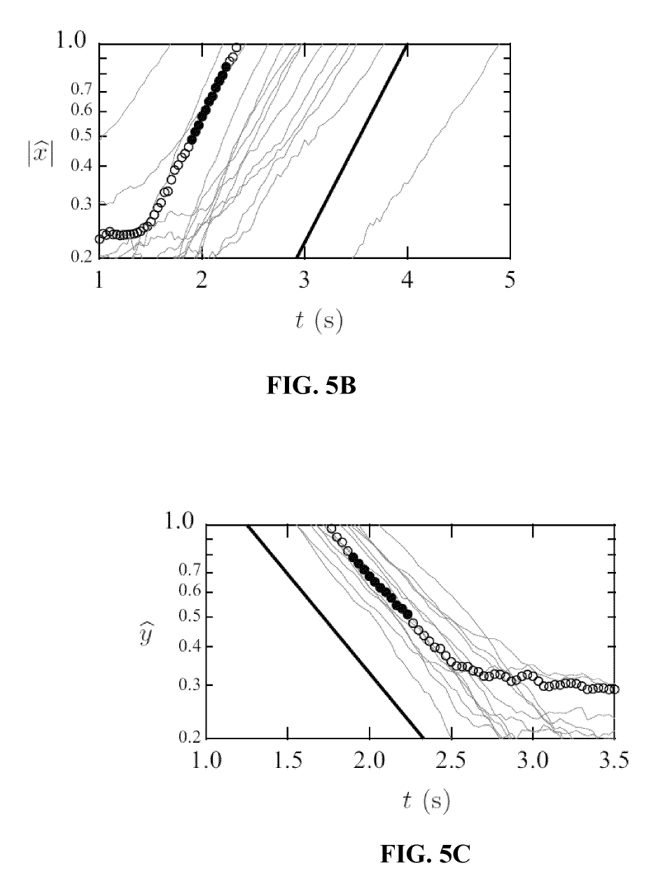

The electric field generated in the T-junction was verified by tracking the center of mass of DNA under conditions in which they do not appreciably deform. We chose to use λ-DNA (48.5 kbp) since it is large enough to easily track, but small enough to not appreciably deform at the conditions used below. Tracking was performed at an applied electric field |E₁|=|E₂|=30 V/cm. The center of mass positions of 34 λ-DNA molecules were tracked using NIH software. FIG. 5(a) shows the trajectories of these molecules in the T-junction vicinity. We first determined the ensemble average electrophoretic velocity in the two uniform regions to be [symbol] μ|E₁| [symbol] =40±4 μm/s. The electrophoretic mobility of λ-DNA can be then determined to be μ=1.35±0.14×10⁻⁴ cm²/(sV). According to the results of the finite element calculation, the strain rate in the extensional region should be \dot{ε}≈0.74 [symbol] μ|E₁| [symbol] /w₃=1.48±0.15 s⁻¹. The relaxation time of λ-DNA in the experimental buffer (5×TBE with 4 vol % β-mercaptoethanol, viscosity η=1.3 cP) has been previously measured²⁰ to be τ=0.19 s. Therefore, the Deborah number for the λ-DNA is De=τ\dot{ε}=0.3, smaller than 0.5. Hence, λ-DNA did not deform significantly in the extensional field and sufficed to serve as tracers.

An experimentally observable strain rate was extracted from the data independently. Fifteen molecules which have experienced the extensional field were selected, and the portion of their trajectories located in the homogeneous extensional region was cropped and the \hat{x} (t) and ŷ (t) data were fit to the exponential functions \hat{x} (t)=\hat{x} (0) exp (\dot{ε}_{obs}t) and ŷ(t)=ŷ(0) exp(−\dot{ε}_{obs}t), respectively. Based on the results of the finite element calculation, we only selected the portion of the trajectory with both |\hat{x}| and ŷ; in the range of [0, 0.8] for the fitting. In FIG. 5 we showed an example of the fitting using open circles to indicate a qualified DNA trajectory and filled circles to indicate the part used for the fitting. The fitted ensemble average strain rate is [symbol] \dot{ε}_{obs} [symbol] =1.49±0.4 s⁻¹, comparable to the predicted value of 1.48±0.4 s⁻¹. This result confirms that the field within the T-junction is nearly homogeneous and the magnitude is in quantitative agreement with the prediction. FIGS. 5(b) and (c) show the semi-log plots of the \hat{x} and ŷ data of the 15 trajectories. The thick black line is the affine scaling using \dot{ε}=1.49 s⁻¹.

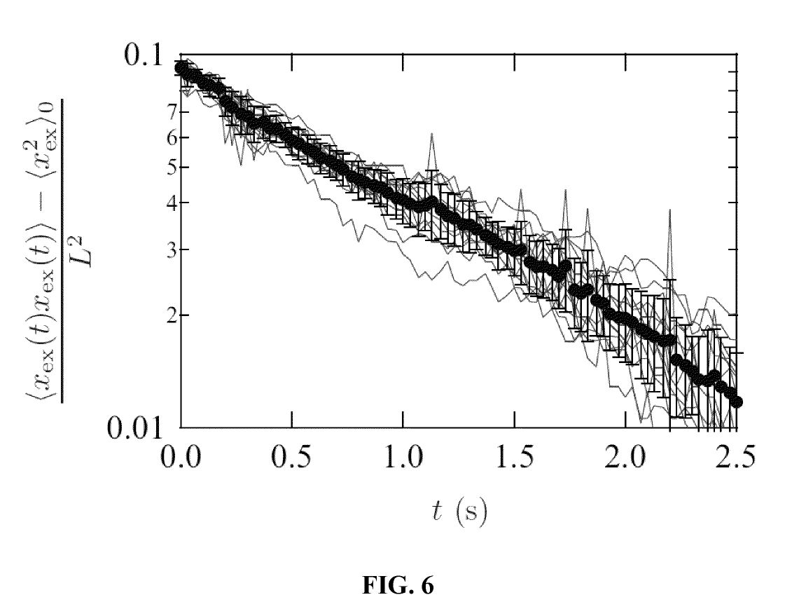

The relaxation time of T4 DNA in the experimental buffer and in the 2 μm-high T channel was experimentally determined by electrophoretically stretching the DNA at the stagnation point, turning off the field and tracking the extension xₑₓ(t) for these relaxing molecules. The extension data were fit to a function [symbol] xₑₓ(t)xₑₓ(t) [symbol] =xᵢ²− [symbol] xₑₓ² [symbol] ) exp (−t/τ)+ [symbol] xₑₓ² [symbol] in the linear force regime, where xᵢ is the initial stretch (about 30% extended for linear regime) and [symbol] xₑₓ² [symbol] corresponds to the mean square coil size at equilibrium which was measured to be 21 μm² in the 2 μm-high channel. FIG. 6 shows the mean squared fractional extension (( [symbol] xₑₓ(t) xₑₓ(t) [symbol] − [symbol] xₑₓ² [symbol] )/L²) data for 16 T4 DNA molecules (lines) and the ensemble average (symbols). The resulting relaxation time is τ=1.3±0.2 s.

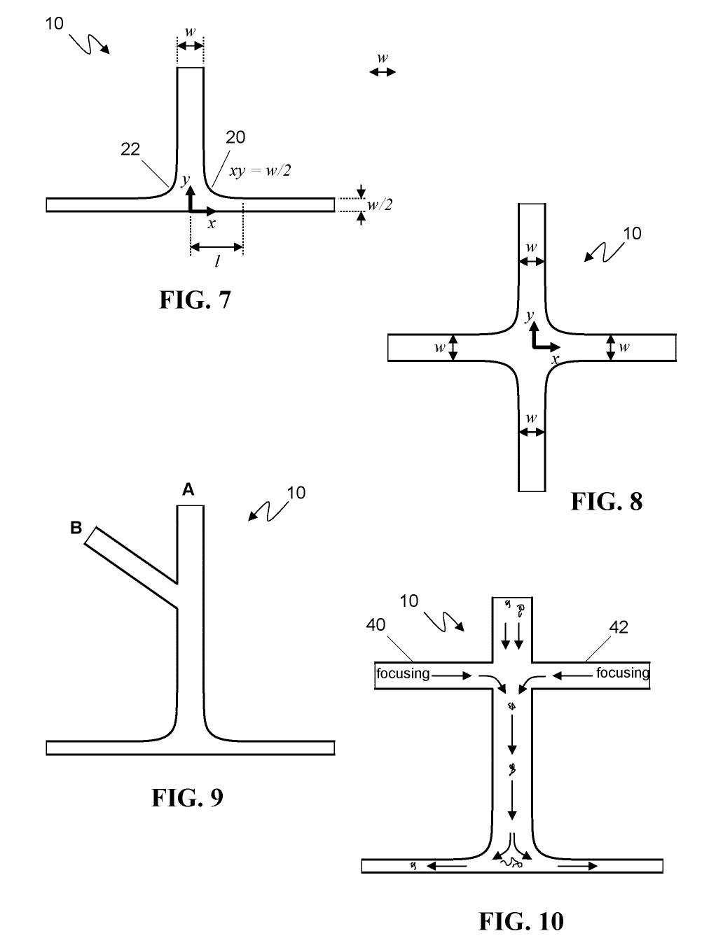

Other embodiments of the invention will now be described in conjunction with FIGS. 7-10. With reference first to FIG. 7, the channel 10 includes corners 20 and 22 rounded using various curves which result in different types of transition from the elongational field to uniform field. For example, a hyperbolic function xy=lw/2 (w and l are shown in the figure) can be used to round the corners so that the resulting channel provides a homogeneous elongational electric field within the region −l≦x≦l and 0≦y≦1. The field transition is immediate and the entrance effect is almost completely suppressed in this type of T channel. The stretching of DNA with contour lengths less than 2l is purely governed by the Deborah number De. As shown in FIG. 8, a full cross-slot channel 10 (the T channel discussed above can be imagined as half of the cross-slot channel) can also be used for biomolecule trapping and manipulation. The four straight arms have identical width and length, and the corners can be rounded in the same manner as for the T channel. The trapping still depends on the local planar elongational electric field with a stagnation point located in the center of the junction region. The operating principle of the cross-slot device is the same with that of the T channel embodiments described above.

FIG. 9 illustrates an embodiment of the invention in which the T channel has an extra side injection part. Such a modification on the top arm of the T channel will allow more potential biological applications. One (or more) side injection channels can be added so that when a DNA molecule (or other biomolecule) is trapped at the stagnation point, other biological molecules (e.g., proteins) can be sent into the junction through these injection channels. As a result, the interaction between multiple molecules can be visualized and studied. FIG. 9 shows a T channel with one injection channel added. DNA molecules are loaded from terminal A and electrophoretically driven down into the junction and stretched. Other molecules of interest can be injected from terminal B afterwards. Yet another embodiment of the invention is shown in FIG. 10. Two focusing channels 40 and 42 having identical lengths and widths are added upstream of the T junction. When symmetric potentials are applied, these two channels 40 and 42 help focus DNA into the center line of the top arm. As a result, most of the DNA molecules entering the junction will move straightly towards the stagnation point and thus can be easily trapped and stretched. The two focusing channels 40 and 42 reduce the amount of controlling required for the trapping process. This type of T channel has the potential for performing a continuous process wherein the molecules are fed into the junction, trapped, stretched, and released one by one, as demonstrated in FIG. 10.

Our DNA trapping and stretching device has several advantages over other methods. Electric fields are much easier to apply, control and their connections have smaller lag times than hydrodynamic fields in micro/nano channels. Further, the purely elongational kinematics of electric fields are advantageous for molecular stretching. The field boundary conditions also allow for the use of only three connecting channels to generate a homogenous elongational region and straightforward capture of a molecule by adjusting the stagnation point. Stretching can occur even beyond the elongational region due to a molecule straddling the T-junction and feeling a tug-of-war on the arms by opposing fields. The fabrication is also quite simple compared to nanochannels and the design allows for facile capture, stretch and release of a desired molecule.

### REFERENCES

1. E. Y. Chan, N. M. Golncalves, R. A. Haeusler, A. J. Hatch, J. W. Larson, A. M. Maletta, G. R. Yantz, E. D. Carstea, M. Fuchs, G. G. Wong, S. R. Gullans, R. Gilmanshin, Genome Res. 14, 1137 (2004).
2. E. S. G. Shaqfeh, J. Non-Newtonian Fluid Mech. 130, 1 (2005).
3. C. Bustamante, J. Macosko, and G. Wuite, Nat. Rev. Mol. Cell Biol. 1, 130 (2000).
4. S. Ferree and H. W. Blanch, Biophys. J. 85, 2539 (2003).
5. T. T. Perkins, D. E. Smith, R. G. Larson, and S. Chu, Science 268, 83 (1995).
6. J. O. Tegenfeldt, C. Prinz, H. Cao, S. Chou, W. W. Reisner, R. Riehn, Y. M. Wang, E. C. Cox, J. C. Sturm, P. Silberzan, et al., P.N.A.S. 101, 10979 (2004).
7. K. Jo, D. Dhingra, T. Odijk, J. de Pablo, M. Graham, R. Runnheim, D. Forrest, and D. Schwartz, P.N.A.S. 104, 2673 (2007).
8. T. T. Perkins, D. E. Smith, and S. Chu, Science 276, 2016 (1997).
9. C. M. Schroeder, H. P. Babcock, E. S. G. Shaqfeh, and S. Chu, Science 301, 1515 (2003).
10. A. E. Cohen and W. Moerner, App. Phys. Lett. 86, 093109 (2005).
11. O. B. Bakajin, T. A. J. Duke, C. F. Chou, S. S. Chan, R. H. Austin, and E. C. Cox, Phys. Rev. Lett. 80, 2737 (1998).
12. G. C. Randall and P. S. Doyle, Phys. Rev. Lett. 93, 058102 (2004).
13. G. C. Randall and P. S. Doyle, Macromolecules 38, 2410 (2005).
14. G. C. Randall, K. M. Schultz, and P. S. Doyle, Lab Chip 6, 516 (2006).
15. Y. J. Juang, S. Wang, X. Hu, and L. J. Lee, Phys. rev. Lett. 93, 268105 (2004).
16. G. C. Randall and P. S. Doyle, Mat. Res. Soc. Proceedings 790, 3.3.1 (2003).
17. See EPAPS Document No. ______ for supplemental information. This document can be reached via a direct link in the online article's HTML reference section or via the EPAPS homepage (http://www.aip.org/pubservs/epaps.html).
18. Y. Xia and G. M. Whitesides, Angew. Chem., Int. Ed. 37, 550 (1998).
19. A. Balducci, P. Mao, J. Han, and P. S. Doyle, Macromolecules 39, 6273 (2006).
20. G. C. Randall and P. S. Doyle, Macromolecules 38, 2410 (2005).

It is recognized that modifications and variations of the invention disclosed herein will be apparent to those of ordinary skill in the art and it is intended that all such modifications and variations be included within the scope of the appended claims.

What is claimed is:

1. System for trapping and stretching biomolecules comprising:
a microfluidic device including a symmetric channel forming a T-shaped junction at a narrow center region and three wider portions outside the center region; and
at least one power supply for generating an electric potential across the T-shaped junction to create a local planar extensional field having a stagnation point in the junction, whereby a biomolecule introduced into the microfluidic device is trapped at the stagnation point and stretched by the extensional field.

2. The system of claim 1 wherein the symmetric junction includes a vertical arm and two horizontal arms, the three arms having substantially identical lengths and the width of the vertical arm being approximately twice the width of the horizontal arms.

3. The system of claim 1 including two separate DC power supplies to adjust the location of the stagnation point.

4. The system of claim 1 wherein corners in the center region are rounded.

5. The system of claim 2 wherein the vertical arm and the two horizontal arms contain uniform electric fields.

6. The system of claim 1 wherein the extensional field is substantially homogenous.

7. The system of claim 1 wherein the biomolecule is DNA.

8. The system of claim 7 wherein the DNA is T4 DNA.

9. The system of claim 7 wherein the DNA molecule has an electrical Deborah number exceeding 0.5.

10. The system of claim 1 wherein the biomolecule is selected from the group consisting of DNA, cells, proteins, viruses, and biopolymers.

11. The system of claim 10 wherein the biopolymer is actin.

12. The system of claim 2 wherein the vertical arm includes a side injection part.

13. The system of claim 2 wherein the vertical arm includes two focusing channels communicating therewith.

14. System for trapping and stretching biomolecules comprising:
a microfluidic device including a full cross-slot channel including a junction; and
at least one power supply for generating an electric potential across the junction to create a local planar extensional field having a stagnation point in the junction, whereby a biomolecule introduced into the microfluidic device is trapped at the stagnation point and stretched by the extensional field.
